(19) United States
(12) Patent Application Publication
(10) Pub. No.: US 2016/0098736 A1
(43) Pub. Date: Apr. 7, 2016

(54) SUGGESTION ENGINE FOR CUSTOMER RELATIONSHIP MANAGEMENT

(71) Applicant: SugarCRM Inc., Cupertino, CA (US)

(72) Inventors: Jason McDowall, El Segundo, CA (US); Somrat Niyogi, Cupertino, CA (US); Wiebke Poerschke, Cupertino, CA (US); Andreas Sandberg, Pacifica, CA (US); Yuk Lai Suen, Menlo Park, CA (US); Nebojsa Vislavski, Cupertino, CA (US)

(21) Appl. No.: 14/877,237

(22) Filed: Oct. 7, 2015

Related U.S. Application Data
(60) Provisional application No. 62/060,758, filed on Oct. 7, 2014.

(51) Int. Cl. G06Q 30/02

(52) U.S. Cl. CPC G06Q 30/0202; G06Q 30/0201

(57) ABSTRACT

A method, system and computer program product for suggestion processing in a customer relationship management (CRM) computing system is provided. The method includes communicatively coupling a pre-processor to different data sources of CRM related data of a CRM computing system and monitoring by the pre-processor the different data sources. In response to detecting changes in one or more of the different data sources, the pre-processor identifies different correlated actions to be suggested in connection with the detected changes, rates each of the correlated actions according to a combination of individual importance metrics computed for the correlated actions, filters the rated correlated actions to a subset based upon one or more filtering rules and presents in a user interface to the pre-processor each remaining correlated action along with a user interface control adapted to respond to activation by directing the CRM computing system to perform a corresponding correlated action.

### CROSS-REFERENCE TO RELATED APPLICATION

This application claims the benefit under 35 U.S.C. §119(e) of U.S. Provisional Patent Application No. 62/060,758 filed Oct. 7, 2014, the teachings of which are incorporated by reference herein in its entirety.

### BACKGROUND OF THE INVENTION

1. Field of the Invention

The present invention relates to customer relationship management (CRM) computing systems and more particularly to action management in a CRM computing system.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM systems are often used to manage the entire lifecycle of a relationship between a customer and an organization. In this regard, a CRM system is enabled to manage tasks for organizational representatives associated with the targeting and acquisition of a new customer, the fulfillment of a sale to a new customer or an existing customer, and the maintenance of a relationship with an existing customer. Much of the role of the CRM system is to store data documenting the relationship between representatives of an organization and its customers and prospective customers and to schedule actions to be performed by end users in order to further the relationship with customers and potential customers.

To that end, CRM systems store troves of data pertaining to the human-to-human interactions between representatives of an organization and corresponding customers. This interactions data is leveraged in one of two ways. First, this interactions data is used to record the nature of the development of a relationship with a prospective customer. Second, this interactions data is used as a means to supervise the performance of the organizational representatives so as to gauge the progress of the organization in meetings its sales and support objectives. Recent advances in CRM have allowed for the prediction of one or more effective actions to be performed in a CRM computing system so as to achieve the ultimate goal of closing a sale and servicing the needs of an existing customer to allow for future sales.

### BRIEF SUMMARY OF THE INVENTION

Embodiments of the present invention address deficiencies of the art in respect to CRM action management and provide a novel and non-obvious method, system and computer program product for suggestion processing in a CRM computing system. In an embodiment of the invention, a method for suggestion processing in a CRM computing system includes communicatively coupling a pre-processor executing in memory of a host computing system to different data sources of CRM related data of a CRM computing system and monitoring by the pre-processor the different data sources. In response to detecting changes in one or more of the different data sources, the pre-processor identifies different correlated actions to be suggested in connection with the detected changes, rates each of the correlated actions according to a combination of individual importance metrics computed for the correlated actions, filters the rated correlated actions to a subset based upon one or more filtering rules and presents in a user interface to the pre-processor each remaining correlated action along with a user interface control adapted to respond to activation by directing the CRM computing system to perform a corresponding correlated action.

In one aspect of the embodiment, the different data sources consist essentially of an e-mail inbox of an end user of the CRM computing system, a calendar of the end user, an address book of the end user and a task list of the end user. Other examples include news feeds, and recorded contact interaction such as engagement with a product, website, or other content. As such, one of the changes is a date change in the calendar and one of the different correlated actions includes a suggestion to send either a meeting confirmation message or a meeting follow-up message to a contact in the address book with whom a meeting had been scheduled with the end user for a date and time within a threshold period of time of the date change. As well, when one of the changes is a date change in the calendar, one of the different correlated actions may include a suggestion to populate a form in the CRM computing system for a contact in the address book with whom a meeting had been scheduled with the end user for a date and time within a threshold period of time of the date change. Even further, when one of the changes is a date change in the calendar, one of the different correlated actions may include a suggestion to send a reconnect message to a contact in the address book with whom no messages had been previously exchanged with the end user for a threshold period of time of the date change.

In another aspect of the embodiment, the importance metrics include a value computed for a corresponding correlated action based upon an empirically observed impact of the corresponding correlated action on closing a sale with a customer. The importance metrics also may include a value computed for the end user based upon how often in the past the end user has activated a user interface control of the corresponding correlated action to direct a performance of the corresponding correlated action. Yet further, the importance metrics may include a value computed for the corresponding correlated action based upon a temporal proximity to a deadline to perform the corresponding correlated action. Finally, the importance metrics may include a value computed for the corresponding correlated action based upon a determined importance of a contact referenced in connection with the corresponding correlated action.

In another embodiment of the invention, a CRM computing system is configured for suggestion processing. The system includes a host computing system including one or more computers each with memory and at least one processor and a pre-processor executing in memory of the host computing system and coupled to different data sources of CRM related data of a CRM computing system over a computer communications network. The pre-processor includes program code enabled upon execution in the host computing system to monitor the different data sources and to respond to detecting changes in one or more of the different data sources by identifying different correlated actions to be suggested in connection with the detected changes, rating each of the correlated actions according to a combination of individual importance metrics computed for the correlated actions, filtering the rated correlated actions to a subset based upon one or more filtering rules and presenting in a user interface to the pre-processor each remaining correlated action along with a user interface control adapted to respond to activation by directing the CRM computing system to perform a corresponding correlated action.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for suggestion processing in a CRM computing system;

FIG. 2 is a schematic illustration of a CRM data processing system configured for suggestion processing; and,

FIG. 3 is a flow chart illustrating a process for suggestion processing in a CRM computing system.

### DETAILED DESCRIPTION OF THE INVENTION

Embodiments of the invention provide for suggestion processing in a CRM computing system. In accordance with an embodiment of the invention, different data sources of CRM related data are monitored by a pre-processor to identify correlated actions to be suggested in connection with changes to the different data sources, such as impending meetings, changes to a list of contacts, newly received or transmitted e-mail messages, and the like. The suggested actions are rated according to importance metrics computed for each of the suggested actions and then the rated suggested actions are filtered to a subset based upon one or more filtering rules. Finally, each remaining suggested action is presented in a display with a user interface control responsive to the activation of which, the corresponding suggested action is performed.

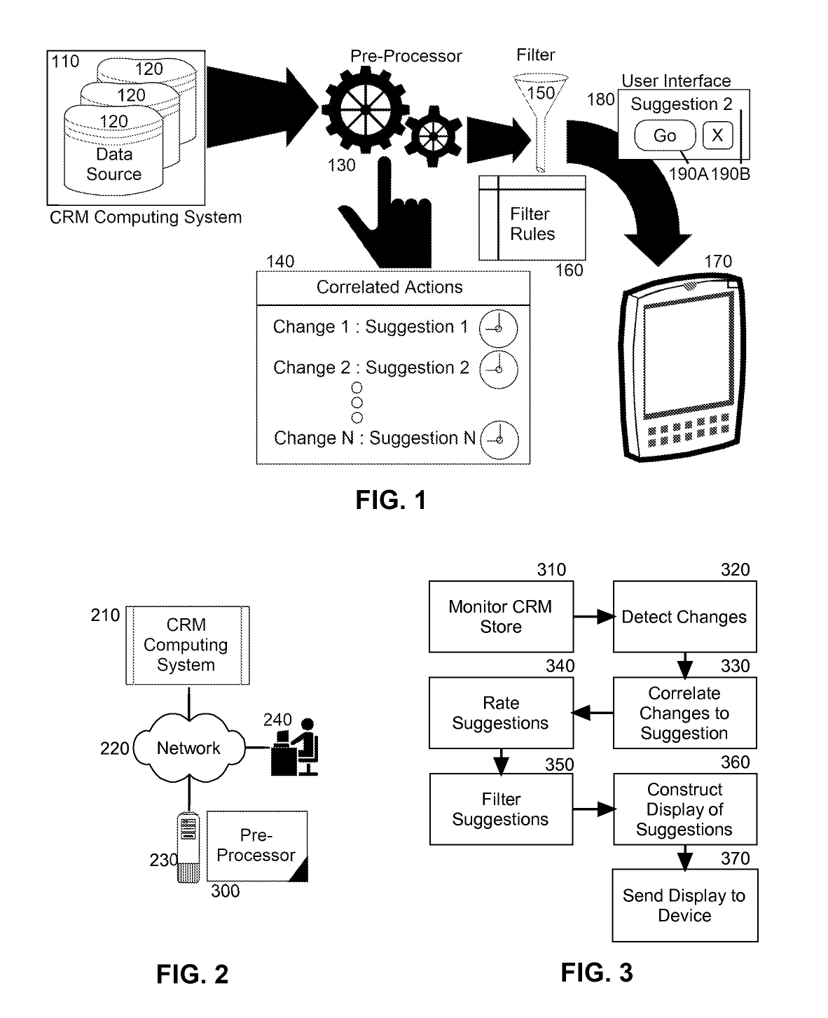

In further illustration, FIG. 1 pictorially shows a process for suggestion processing in a CRM computing system. As shown in FIG. 1, a pre-processor 130 monitors changes to CRM data disposed in different CRM data sources 120 within a CRM computing system 110. Upon detecting changes in the data, the pre-processor 130 looks up a table of correlated suggested actions 140 in the CRM application that optionally include a rating for each correlated action. The pre-processor 130 then applies a filter 150 based upon one or more filter rules 160 specifying which of the suggestions to include in a subset and an order in which to present the suggestions in the subset. Finally, each of the remaining suggestions can be presented in a user interface 180 for display in a computing device 170. The user interface 180 includes not only the suggestion 190B but also an activatable user interface control 190A in response to the activation of which the suggested action is performed.

The process described in connection with FIG. 1 is implemented in a CRM data processing system. In further illustration, FIG. 2 schematically shows a CRM data processing system configured for suggestion processing. The system includes a host computing system 230 with memory and at least one processor. The host computing system 230 is communicatively coupled to a CRM computing system 210 over computer communications network 220. The host computing system 230 additionally supports the execution therein of a pre-processor 300. The pre-processor 300 includes program code that when executed in the memory of the host computing system 230 is enabled to monitor different data sources in the CRM computing system 210 such as an e-mail inbox for each end user of the CRM computing system, a calendar of the end user, an address book of the end user and a task list of the end user, news feeds, and recorded contact interaction such as engagement with a product, website, or other content.

During monitoring, the program code of the pre-processor 300 detects one or more changes to data in the data sources of the CRM computing system 210, such as a date change in the calendar. Thereafter, the program code of the pre-processor 300 correlates each detected change in data in the data sources of the CRM computing system 210 to a suggested action to be performed in connection with the CRM computing system 210. For example, in response to a detected date change the calendar, one of the different correlated actions includes a suggestion to send either a meeting confirmation message or a meeting follow-up message to a contact in the address book with whom a meeting had been scheduled with the end user for a date and time within a threshold period of time of the date change. As well, when one of the changes is a date change in the calendar, one of the different correlated actions may include a suggestion to populate a form in the CRM computing system for a contact in the address book with whom a meeting had been scheduled with the end user for a date and time within a threshold period of time of the date change. Even further, when one of the changes is a date change in the calendar, one of the different correlated actions may include a suggestion to send a reconnect message to a contact in the address book with whom no messages had been previously exchanged with the end user for a threshold period of time of the date change.

In any event, the program code of the pre-processor 300 computes a rating for each suggested action correlated to a corresponding one of the changes in data based upon different importance metrics. For example, the importance metrics may include a value computed for a corresponding correlated action based upon an empirically observed impact of the corresponding correlated action on closing a sale with a customer or retaining an existing relationship with a customer, both as indicated within the CRM computing system 210. The importance metrics also may include a value computed for the end user based upon how often in the past the end user has activated a user interface control of the corresponding correlated action to direct a performance of the corresponding correlated action. Yet further, the importance metrics may include a value computed for the corresponding correlated action based upon a temporal proximity to a deadline to perform the corresponding correlated action. Finally, the importance metrics may include a value computed for the corresponding correlated action based upon a determined importance of a contact referenced in connection with the corresponding correlated action. The program code of the pre-processor 300 particularly may combine multiple different importance metrics to produce a composite score as the rating and any one or more of the importance metrics may be weighted in accordance with its perceived importance.

Thereafter, the program code of the pre-processor 300 filters the correlated suggested actions based upon the rating of each correlated suggested action, and in accordance with one or more filter rules specifying criteria for filtering suggested actions. The filtering of the program code of the pre-processor 300 produces a subset of correlated suggested actions each of which is used by the program code of the pre-processor 300 to generate a different user interface in which the corresponding one of the suggested actions is presented along with a user interface control programmed to direct the performance of the suggested action upon activation of the user interface control.

In even yet further illustration of the operation of the pre-processor 300, FIG. 3 is a flow chart illustrating a process for suggestion processing in a CRM computing system. Beginning in block 310, one or more CRM data stores are monitored for changes in data stored therein and in block 320, one or more changes to the data are detected. In block 330, each detected change in data is correlated to one or more suggested actions to be performed in connection with a coupled CRM computing system. In block 340, each of the correlated suggested actions are rated and in block 350 the correlated suggested actions are filtered at least in part based upon the ratings in order to produce a subset of correlated suggested actions. In block 360 a display of the correlated suggested actions from the subset is constructed with each correlated suggested action having an associated user interface control programmed to direct the performance of the suggested action upon activation of the user interface control. Finally, in block 370 the display is sent to a computing device for presentation therein.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for suggestion processing in a customer relationship management (CRM) computing system, the method comprising:
communicatively coupling a pre-processor executing in memory of a host computing system to different data sources of CRM related data of a CRM computing system;
monitoring by the pre-processor the different data sources; and,
responsive to detecting changes in one or more of the different data sources, identifying different correlated actions to be suggested in connection with the detected changes, rating each of the correlated actions according to a combination of individual importance metrics computed for the correlated actions, filtering the rated correlated actions to a subset based upon one or more filtering rules and presenting in a user interface to the pre-processor each remaining correlated action along with a user interface control adapted to respond to activation by directing the CRM computing system to perform a corresponding correlated action.

2. The method of claim 1, wherein the different data sources consist essentially of an e-mail inbox of an end user of the CRM computing system, a calendar of the end user, an address book of the end user and a task list of the end user.

3. The method of claim 2, wherein one of the changes is a date change in the calendar and one of the different correlated actions includes a suggestion to send either a meeting confirmation message or a meeting follow-up message to a contact in the address book with whom a meeting had been scheduled with the end user for a date and time within a threshold period of time of the date change.

4. The method of claim 2, wherein one of the changes is a date change in the calendar and one of the different correlated actions includes a suggestion to populate a form in the CRM computing system for a contact in the address book with whom a meeting had been scheduled with the end user for a date and time within a threshold period of time of the date change.

5. The method of claim 2, wherein one of the changes is a date change in the calendar and one of the different correlated actions includes a suggestion to send a reconnect message to a contact in the address book with whom no messages had been previously exchanged with the end user for a threshold period of time of the date change.

6. The method of claim 1, wherein the importance metrics include a value computed for a corresponding correlated action based upon an empirically observed impact of the corresponding correlated action on closing a sale with a customer.

7. The method of claim 1, wherein the importance metrics include a value computed for the end user based upon how often in the past the end user has activated a user interface control of the corresponding correlated action to direct a performance of the corresponding correlated action.

8. The method of claim 1, wherein the importance metrics include a value computed for the corresponding correlated action based upon a temporal proximity to a deadline to perform the corresponding correlated action.

9. The method of claim 1, wherein the importance metrics include a value computed for the corresponding correlated action based upon a determined importance of a contact referenced in connection with the corresponding correlated action.

10. A customer relationship management (CRM) computing system configured for suggestion processing, the system comprising:
a host computing system comprising one or more computers each with memory and at least one processor; and,
a pre-processor executing in memory of the host computing system and coupled to different data sources of CRM related data of a CRM computing system over a computer communications network;
the pre-processor comprising program code enabled upon execution in the host computing system to monitor the different data sources and to respond to detecting changes in one or more of the different data sources by identifying different correlated actions to be suggested in connection with the detected changes, rating each of the correlated actions according to a combination of individual importance metrics computed for the correlated actions, filtering the rated correlated actions to a subset based upon one or more filtering rules and presenting in a user interface to the pre-processor each remaining correlated action along with a user interface control adapted to respond to activation by directing the CRM computing system to perform a corresponding correlated action.

11. The system of claim 10, wherein the different data sources consist essentially of an e-mail inbox of an end user of the CRM computing system, a calendar of the end user, an address book of the end user and a task list of the end user.

12. A computer program product for suggestion processing in a customer relationship management (CRM) computing system, the computer program product comprising a computer readable storage medium having program instructions embodied therewith, the program instructions executable by a device to cause the device to perform a method comprising:
communicatively coupling a pre-processor executing in memory of a host computing system to different data sources of CRM related data of a CRM computing system;
monitoring by the pre-processor the different data sources; and,
responsive to detecting changes in one or more of the different data sources, identifying different correlated actions to be suggested in connection with the detected changes, rating each of the correlated actions according to a combination of individual importance metrics computed for the correlated actions, filtering the rated correlated actions to a subset based upon one or more filtering rules and presenting in a user interface to the pre-processor each remaining correlated action along with a user interface control adapted to respond to activation by directing the CRM computing system to perform a corresponding correlated action.

13. The computer program product of claim 12, wherein the different data sources consist essentially of an e-mail inbox of an end user of the CRM computing system, a calendar of the end user, an address book of the end user and a task list of the end user.

14. The computer program product of claim 13, wherein one of the changes is a date change in the calendar and one of the different correlated actions includes a suggestion to send either a meeting confirmation message or a meeting follow-up message to a contact in the address book with whom a meeting had been scheduled with the end user for a date and time within a threshold period of time of the date change.

15. The computer program product of claim 13, wherein one of the changes is a date change in the calendar and one of the different correlated actions includes a suggestion to populate a form in the CRM computing system for a contact in the address book with whom a meeting had been scheduled with the end user for a date and time within a threshold period of time of the date change.

16. The computer program product of claim 13, wherein one of the changes is a date change in the calendar and one of the different correlated actions includes a suggestion to send a reconnect message to a contact in the address book with whom no messages had been previously exchanged with the end user for a threshold period of time of the date change.

17. The computer program product of claim 12, wherein the importance metrics include a value computed for a corresponding correlated action based upon an empirically observed impact of the corresponding correlated action on closing a sale with a customer.

18. The computer program product of claim 12, wherein the importance metrics include a value computed for the end user based upon how often in the past the end user has activated a user interface control of the corresponding correlated action to direct a performance of the corresponding correlated action.

19. The computer program product of claim 12, wherein the importance metrics include a value computed for the corresponding correlated action based upon a temporal proximity to a deadline to perform the corresponding correlated action.

20. The computer program product of claim 12, wherein the importance metrics include a value computed for the corresponding correlated action based upon a determined importance of a contact referenced in connection with the corresponding correlated action.
